(19) United States
(12) Patent Application Publication
(10) Pub. No.: US 2003/0030904 A1
(43) Pub. Date: Feb. 13, 2003

(54) Stereoscopic viewing assembly with adjustable fields of vision in two dimensions

(76) Inventor: Mei-Ling Huang, Taipei Hsien (TW)

Correspondence Address: Mei-Ling Huang, P.O. Box No.6-57, Chung-Ho City, Taipei Hsien 235, TW

(21) Appl. No.: 09/927,380

(22) Filed: Aug. 13, 2001

(51) Int. Cl. G02B 27/22

(52) U.S. Cl. 359/466; 359/477

(57) ABSTRACT

A lightweight viewing assembly for viewing horizontally aligned or vertically arranged stereo images shown on planar panels, particularly those shown on display monitors of computer systems and TV sets is disclosed, which includes a pair of reflector units for directing the sight of each eye toward spaced apart stereo images, a spectacle unit for bearing the reflector units, and a pair of adapter units as an interface between the spectacle unit and the reflector units for directing the sight of each eye toward vertically spaced apart stereo images. Attachment means enables the reflector units and the adapter units to be firmly attached to the spectacle unit and flexibly movable for adjusting the sight of each eye to obtain the best stereoscopic visual quality.

### BACKGROUND OF THE INVENTION

1. Field of the Invention

The present invention relates to a stereoscopic viewing assembly imparting three-dimensional vision to viewers from two-dimensional images, photographs or prints. More particularly, it relates to such an assembly for viewing pairs of stereo images shown on planar display monitors of computer systems or TV sets. The viewing assembly is capable of adjusting the lines of sight of the viewer toward the horizontally aligned or vertically arranged stereo images with arbitrary space in between by adjusting the orientation and the position of the reflector unit. The compact and lightweight structure of the viewing assembly makes it comfortable to wear on the viewer's nose and convenient to use with all kinds of display monitors without specific software and hardware.

2. Description of the Prior Art

It is well known that the sights imparting to two human eyes are slightly different. This slight difference is the so-called parallax or disparity of the human vision. It is this visual disparity that results in the mental vision being three dimensional and gives the perception of depth. The three-dimensional visual perception or stereoscopic vision can be virtually reproduced by imparting a pair of images having an appropriate disparity to the viewer's eyes. There are many ways to reproduce stereoscopic vision. Naked eyes can be separately controlled to focus on the corresponding stereo image in the way of crossed eyes or paralleled eyes. However, the separate control of two eyes to focus on different objects is not a natural way for the human to see, thus requiring some training and also causing inevitable eye strain. It is actually formidable for some people to have stereoscopic vision with naked eyes. Various hand-held stereoscopic viewers have been developed since the presentation of Wheatstone's stereoscope. These stereoscopic viewers are generally cumbersome in use and have limitations in the size of the photographs to be viewed and in the viewing distance. In the technique of anaglyph, images of the stereo pair can be superposed in complimentary colors such as blue and red, and viewed through the color-filtered glasses each filter lens of which will block the image of different color such that each eye receives the right image for obtaining stereoscopic vision. However, due to color filtering, the loss of color information largely degrades the visual quality of stereo images. In a similar technique, the stereo images which are polarized in different directions are superposed and viewed through the polarized glasses with each lens having the same polarization direction with the corresponding image for obtaining stereoscopic vision. For the time being, to display polarized stereo images on computer monitors or TV monitors must rely on some costly displaying technologies and special hardware, and thus impractical for common users.

Recently, a number of techniques that use liquid crystal (LC) shutter glasses for viewing stereo images on computer or TV monitors have been developed. Liquid crystal lenses of the shutter glasses can be enabled to let the light pass through or disabled to block the light. To provide stereoscopic vision, each of the stereo images will be alternatively displayed on the display monitor in a short interval of time, and the shuttering of each liquid crystal lens must be synchronized with the displayed image in a way that while the left-eye image is displayed, the liquid crystal lens for the right eye should be shuttered. As the shuttering speed is high enough, the remnant vision lasted in both eyes will be merged in the human brain to give the three-dimensional perception. To fulfill this requirement, some specific hardware and software are needed to arrange the stereo image in a specific format and synchronize the image display with the shuttering of LC glasses. The methods of field sequential display (or interlaced display), page flipping, line blanking, and sync-doubling are the most representative techniques using LC shutter glasses for stereoscopic vision.

In general, the basic requirement for these techniques to obtain good stereoscopic visual quality is that the alternating speed of displaying stereo images must be high enough. This indicates that the vertical refresh rate of the display monitor or the synchronization speed in shuttering the LC glasses must exceed a minimal value, or 90 Hz. Flickering and ghost effect will occur if vertical refresh rate of the display monitor is not high enough. This actually implies higher expenses to users, since the cost of the display monitor with high vertical refresh rates is always higher than the ordinary one, and this is especially the case for LCD monitors. Moreover, due to the discontinuous and dimmed light behind the LC glasses, users usually feel uncomfortable with eye strain. An additional shortcoming of these techniques is that stereoscopic visual quality always degrades by the halved resolution in the vertical direction. Since the bandwidth of the Internet grows rapidly, it is a common practice to transmit digital images over world-wide webs, and to view images through web page browsers. It is also not uncommon to transmit digital stereo images over the Internet, and to view three-dimensional images with web page browsers. To view stereo images on web pages with LC shutter glasses, web surfers may have to upgrade their systems with a display monitor having high vertical refresh rates, a graphic card supporting the specified stereo format, or a piece of auxiliary hardware. This extra investment and inconvenience have actually become a barricade to the popularity of stereoscopic contents on the Internet.

### SUMMARY OF THE INVENTION

The present invention aims to provide a compact, lightweight, and low-cost stereoscopic viewing assembly which is suitable for wearing on the human nose to view pairs of stereo images shown on all kinds of display monitors without any auxiliary software and hardware. Good stereoscopic visual quality can be obtained by properly directing the field of vision of each eye to the corresponding stereo image and also the distance between the viewer and the display panel.

The present invention is embodied in a viewing assembly that includes a pair of movable reflector units whereby the sight of each eye can be directed to the corresponding image of the stereo pair shown on the planar display panel, a lightweight spectacle unit for bearing the reflector units and for wearing on the human nose, and a pair of adapter units functioning as an interface between the spectacle unit and the reflector units for deflecting the lines of sight by 90 degrees such that the pair of stereo images can be vertically arranged in additional to horizontal alignment. The reflector unit includes a pair of mirrors arranged in a certain manner that directs the light of the image through a magnifying lens to one eye of the viewer. If the pair of stereo images are horizontally aligned, then the pair of reflector units shall be arranged laterally as shown in FIGS. 5 and 6, and each reflector unit is horizontally movable along the joint part of the spectacle unit for adjusting the field of vision. If the pair of stereo images are arranged vertically, the reflector unit will be attached to the adapter unit which is then attached to the spectacle unit as shown in FIGS. 9 and 10. While not in use, the viewing assembly can be folded in a manner shown in FIG. 11, where the reflector units are attached to the spectacle unit with another side and pulled together to minimized the space occupied.

In order that this invention can be more easily understood and put into practical effect, reference will now be made to the accompanying drawings which illustrate preferred embodiments of the invention, wherein:

### BRIEF DESCRIPTION OF THE DRAWINGS

FIG. 1 is an exploded view of the embodiment of the present invention for viewing stereo images which are horizontally aligned.

FIG. 2 is an exploded view for illustrating the assembly of the reflector unit.

FIGS. 3A and 3B illustrate a front view and side view of the reflector unit.

FIGS. 4A-D are sectional views of some embodiments for attaching the reflector units or the adapter units to the bearer of the spectacle unit

FIG. 5 is a perspective view of the embodiment of the present invention for viewing the horizontally spaced stereo images.

FIGS. 6A and 6B are side views of the embodiment of the present invention for illustrating the adjustment of the sight of each eye toward the horizontally spaced apart stereo images by moving the reflector units.

FIG. 7 is an exploded view of the embodiment of the present invention for viewing the stereo images which are vertically arranged.

FIGS. 8A and 8B illustrate a perspective view and sectional view of the adapter unit.

FIG. 9 is a perspective view of the embodiment of the present invention for viewing the vertically spaced stereo images.

FIGS. 10A and 10B are side views of the embodiment of the present invention for illustrating the adjustment of the sight of each eye toward the vertically arranged stereo images by horizontally moving the adapter units and vertically moving the reflector units.

FIG. 11 is a side view of the embodiment of the present invention for illustrating the viewing assembly in a folded manner.

### DETAILED DESCRIPTION OF THE PREFERED EMBODIMENT

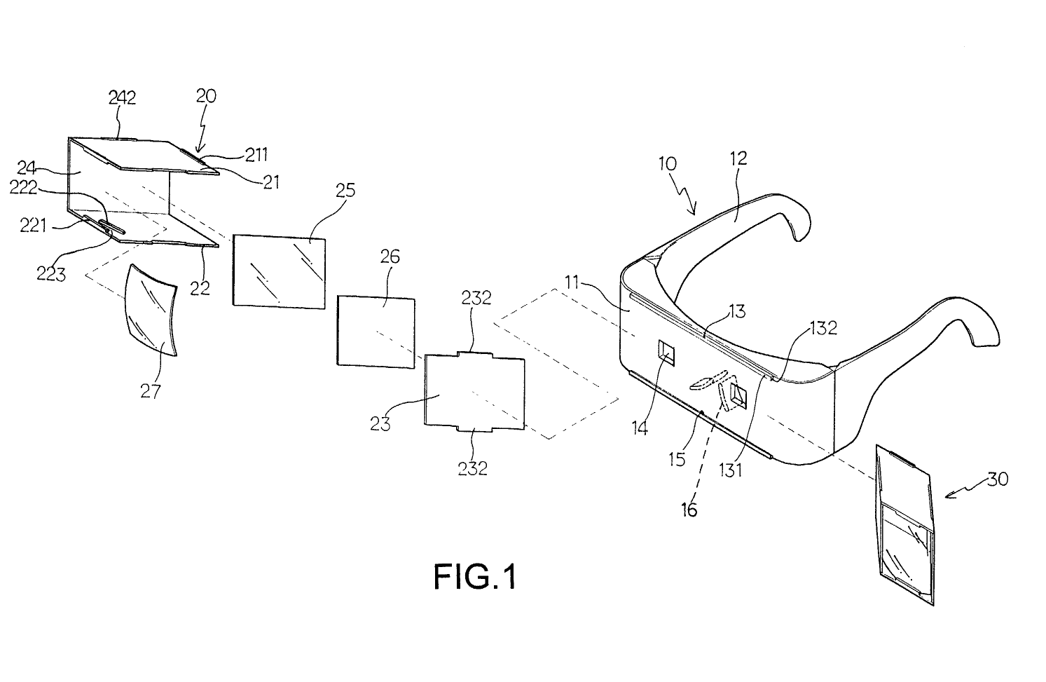

Referring to FIG. 1, said spectacle unit 10 comprises a bearer 11 which bears the reflector units 20, 30 and provides sight openings 14 for permitting the reflected light to be directed toward the viewer's eyes, and the spectacle arms 12 which, as linked to both flanks of the bearer 11, makes the spectacle unit 10 suitable for wearing. The joint part 13 includes the L-shaped rails 131 positioned at the upper and lower edges of the bearer 11 and the attachment slots 132 defined by the space between the front side of the bearer 11 and the L-shaped rails 131. A block 15 is located at the center of the attachment slot 132 to prevent the movable reflector units 20, 30 or the adapter units 40, 50 from crossing over the middle point. Two inclined, curved ledges 16 on the back side of the bearer 11 define a nose receiving well.

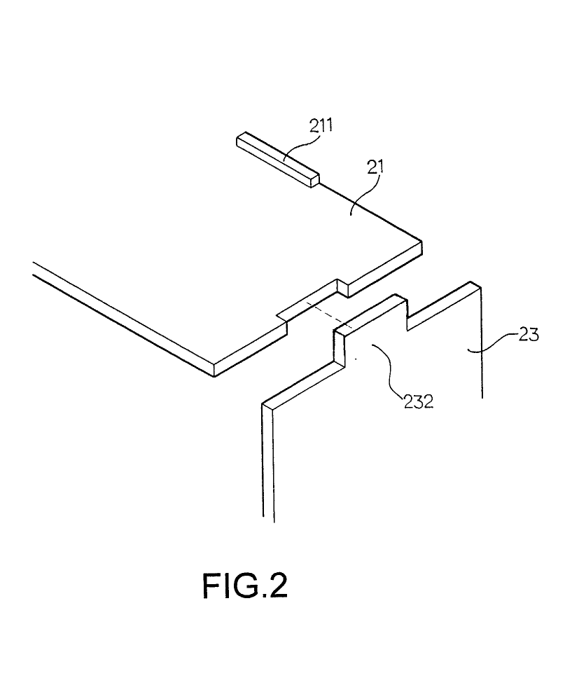

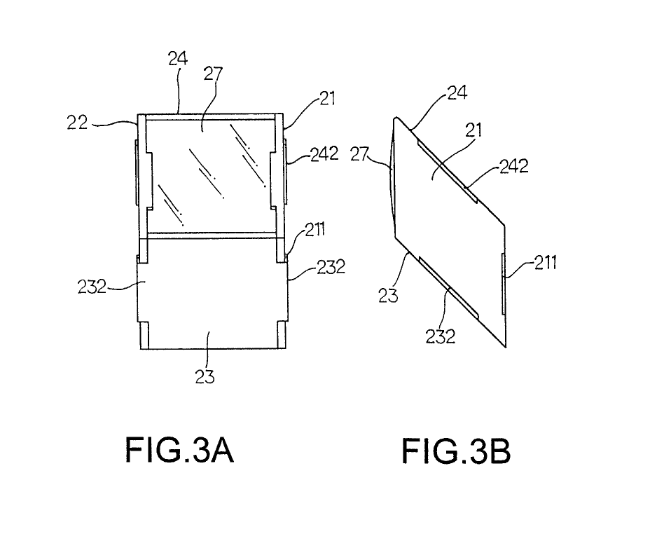

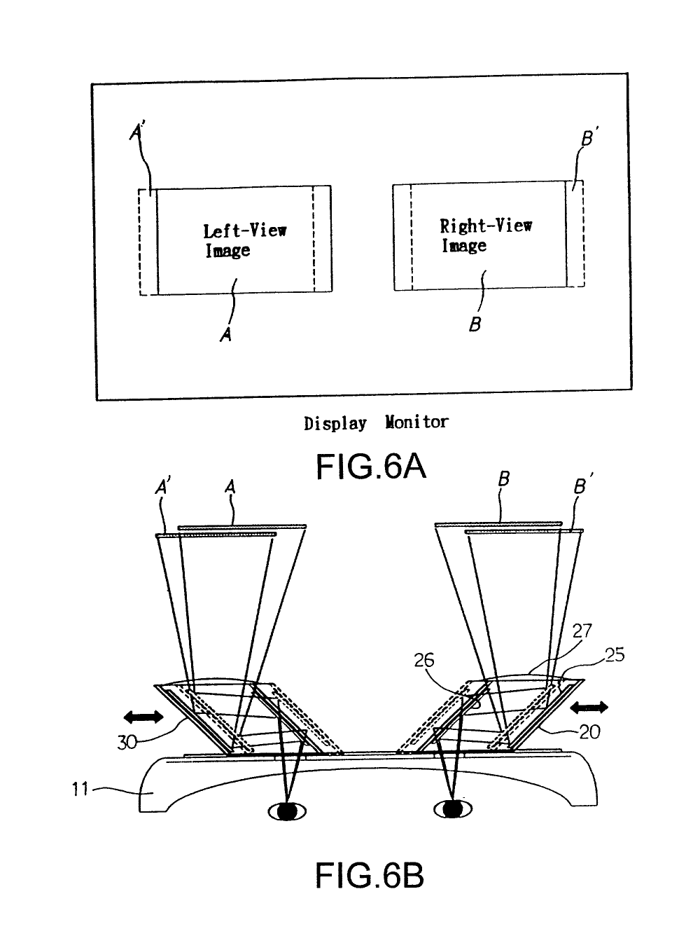

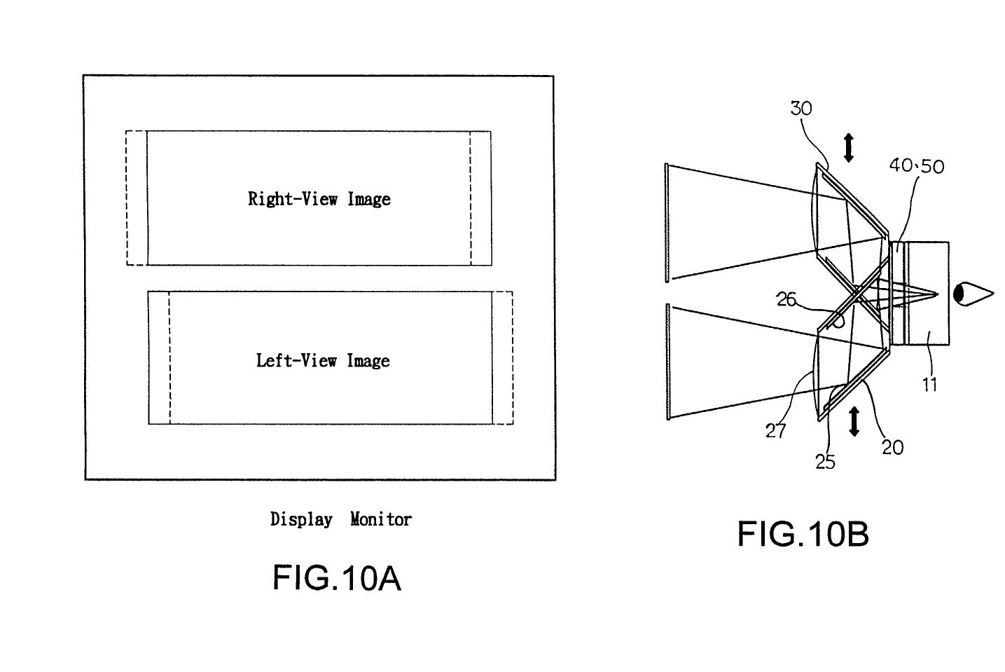

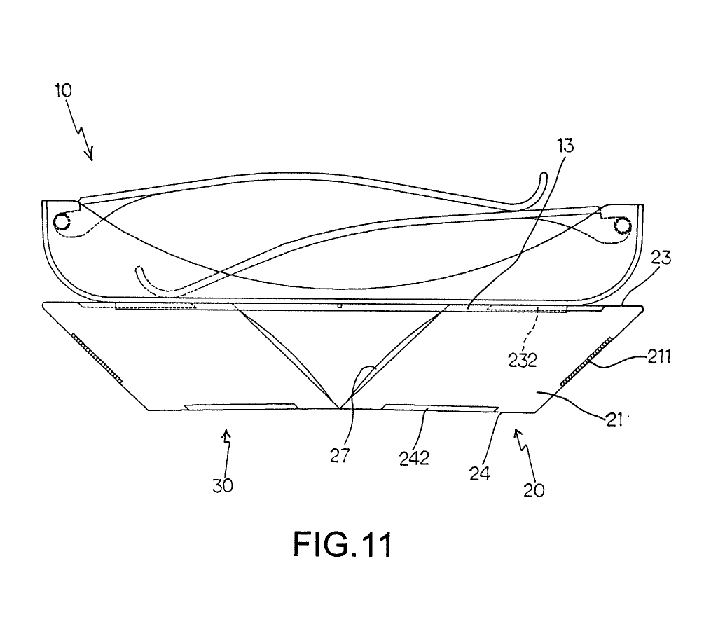

The reflector unit 30 has the same structure as the reflector unit 20 which consists of an upper lid 21, a lower lid 22, a side plate 23 to which a planar mirror 26 is attached, and a side plate 24 to which a planar mirror 25 is attached. On the inner side of the lids 21, 22, positioning bars 221, 222 are arranged to form the slots 223 for accommodating a magnifying lens 27. As shown in FIGS. 6A, 6B, 10A and 10B, the two planar mirrors 25, 26 as attached to side plates 23, 24 are nearly parallel and separated by an appropriate distance to direct the line of sight through the magnifying lens 27 to one of the stereo images shown on the display panel. The lids 21, 22 and the side plate 23, 24 can be assembled by a joint means shown in FIG. 2, to form a tube-like reflector unit. On the outer side of the lids 21, 22, the guiding bars 211 are placed on one edge of the lids 21, 22 for sliding into the attachment slots 132 to allow the reflector unit 20 to be attached to the joint part 13 and movable for adjusting the field of vision of each eye. The extended parts 232, 242 of the side plates 23, 24 also function as the guiding bars that allow the reflector unit 20 to be attached to the joint part 13 in another orientation to minimize the occupied space when the viewing assembly is folded as shown in FIG. 11.

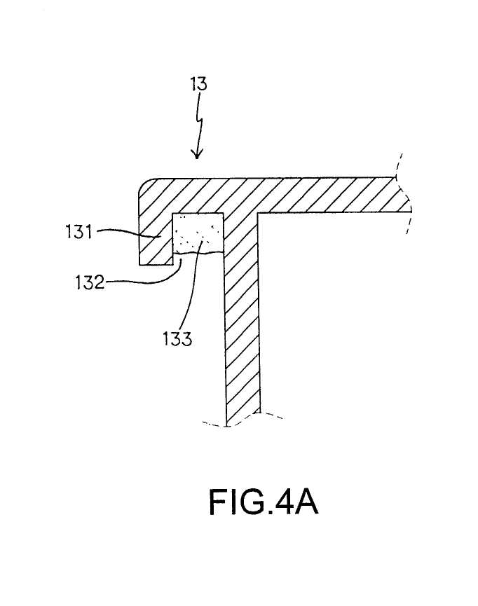

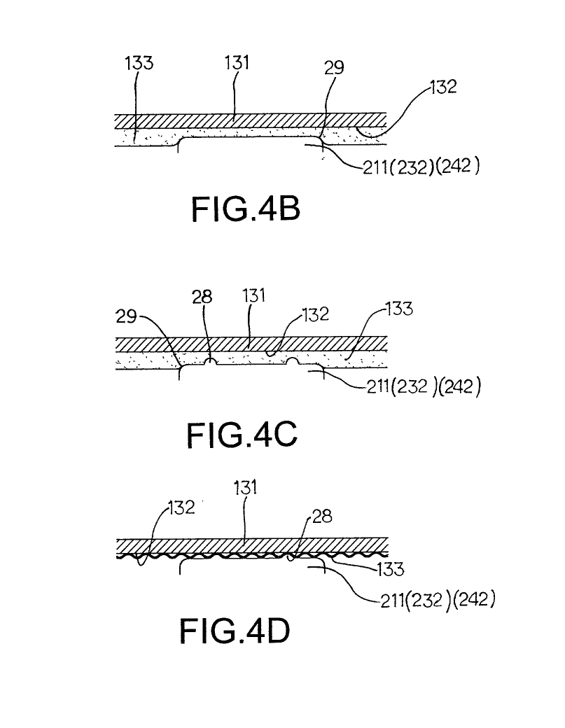

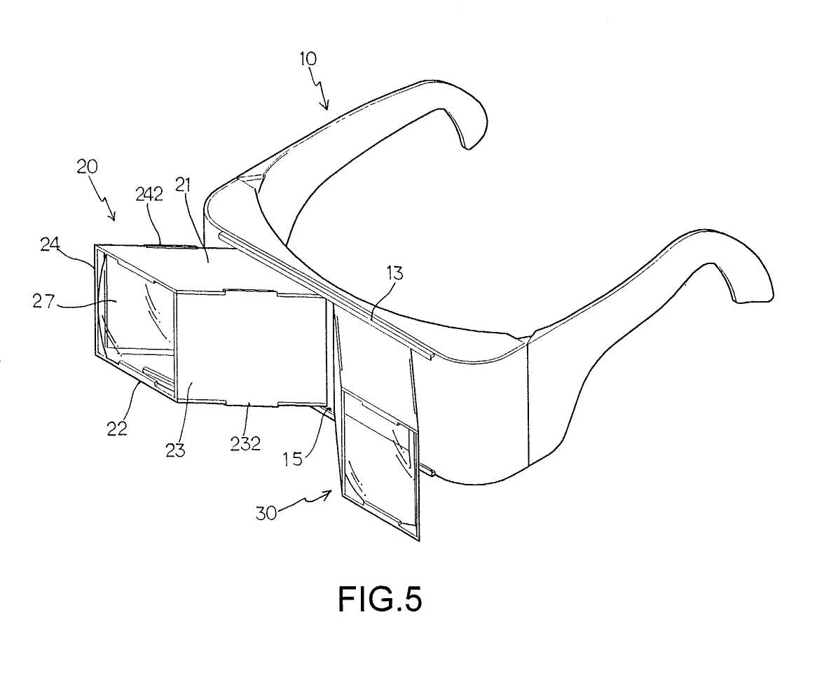

To firmly attach the reflector units 20, 30 to the bearer 11 and also to flexibly move the reflector units 20, 30 over the bearer 11, the fasten means 133 shown in FIG. 4A can be installed in the attachment slots 132 of the joint part 13. The fasten means 133 can be sponge or foam rubber by the elasticity of which the reflector units 20, 30 can be tightly held at a position. With the rounded ends of the guiding bars 211, 232, 242 shown in FIG. 4B, the reflector units 20, 30 can be smoothly moved along the rails 131 of the joint part 13. While in FIG. 4C, the protrusion 28 can be added to the guiding bars 211, 232, 242 to strengthen the tightness for holding the reflector units 20, 30. In FIG. 4D, the fasten means 133 can be the wave-shaped elastic bands to which the protrusion 28 of the guiding bars 211, 232, 242 can be clung to hold the positions of the reflector units 20, 30 and to provide a flexible movement. The movement of the reflector units 20, 30 can change the field of vision of each eye. As shown in FIGS. 6A and 6B, a pair of stereo images A and B are aligned horizontally, each of which will be accommodated in the field of vision of the corresponding eye through the reflector units 20, 30. As the left-view image A shown on the display panel is shifted to the left or replaced by the image A′, the reflector unit 30 should be correspondingly moved to the left to accommodate the image A′ in the field of vision of left eye, and vice versa for the right-view image and the reflector unit 20.

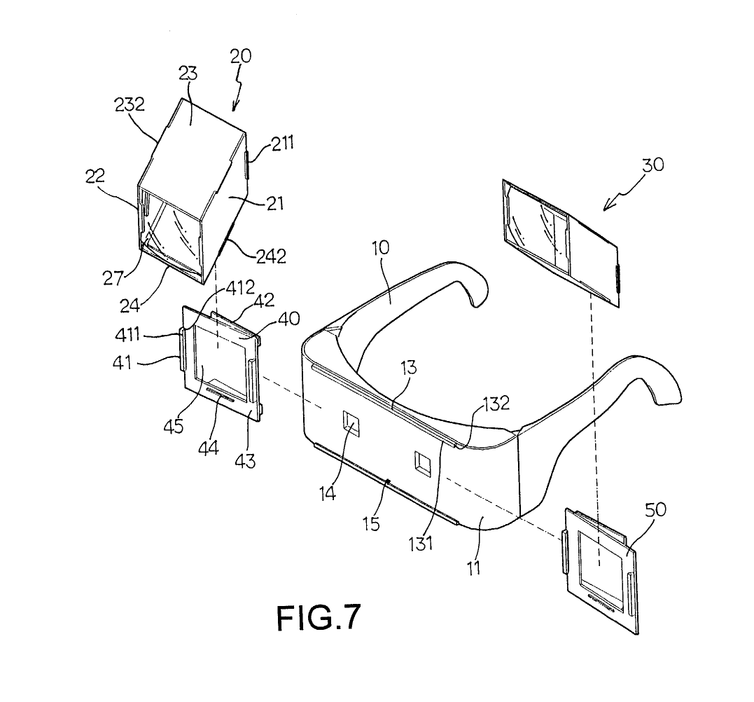

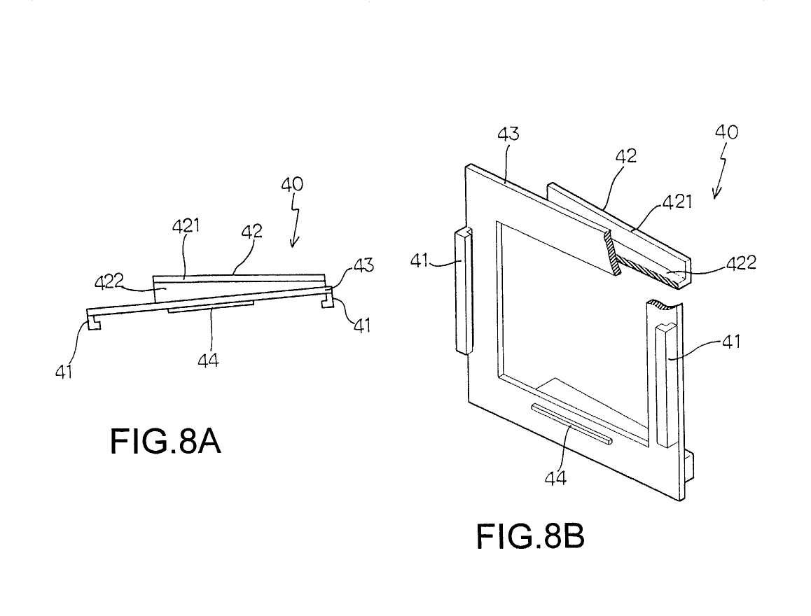

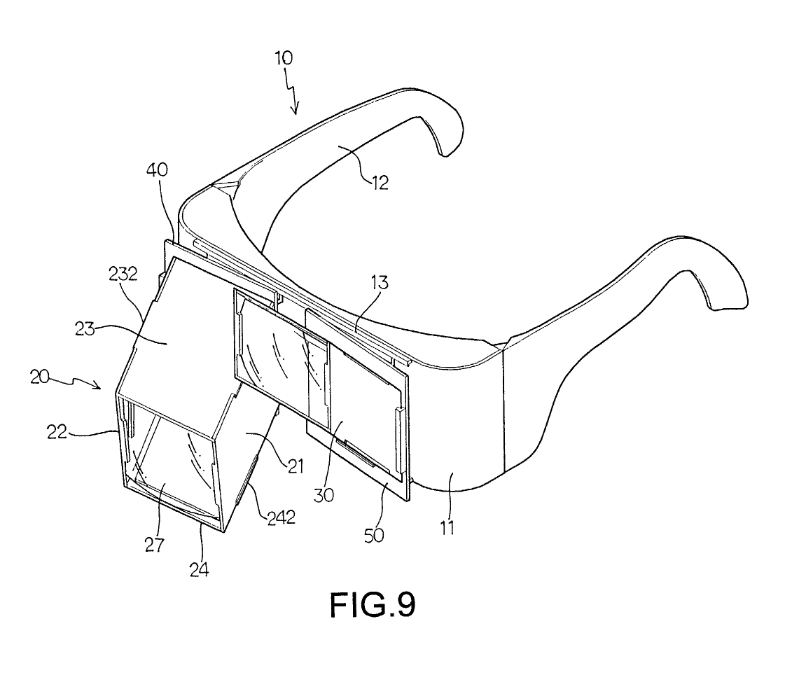

With the adapter units 40, 50 shown in FIG. 7, the viewing assembly can impart three-dimensional vision to the viewer from vertically arranged stereo images shown in FIGS. 10A and 10B. The adapter unit 50 is identical in structure to the adapter unit 40 which is basically a plate 43 with a large opening 45. On the front side of the plate 43, the joint part 41 is placed on two vertical edges for bearing the reflector unit 20 as shown in FIGS. 7 and 9. Referring to FIGS. 7, 8A and 8B, the joint part 41 functioning as the joint part 13 consists of the L-shaped rails 411 and the attachment slots 412. Referring to FIGS. 9, 10A and 10B the reflector units 20 as attached to the adapter units 40 can move vertically to adjust the field of vision in the vertical direction. The fasten means 133 as described in FIG. 4 can also be installed in the attachment slots 412 for providing firm attachment and flexible movement of the reflector unit 20. While on the back side of the plate 43, the joint part 42 shown in FIG. 7 is placed on the upper and lower edges of the plate 43 for attaching to the bearer 11. Referring to FIGS. 8A, 8B and 9, the joining bar 421 which functions as the guiding bars 211 can slide into the attachment slots 132 for allowing the adapter unit 40 to be attached to the joint part 13 and movable along the rails 131 for adjusting the field of vision in the horizontal direction. The joining bar 421 has a gentle slope in relation to the plate 43 for directing the line of sight towards the center of the display panel. This inclination helps the user to view the vertically arranged images which are displayed within a narrow region. To prevent the reflector unit 20 from falling off the adapter units 40, a block 44 is placed near the bottom edge of the plate 43. By moving the adapter units 40, 50 along the horizontal direction and moving the reflector units 20, 30 along the vertical direction, the sight of each eye can be adjusted in two dimensions, and thus allowing the left-view and right-view images to be more flexibly arranged.

While not in use, the viewing assembly can be folded in a manner shown in FIG. 11, where the reflector unit 20 are attached to the spectacle unit 10 by sliding the guiding bars 232 or 242 into the attachment slot 132, and moved along the rails 131 toward the center and positioned against the reflector unit 30 to minimize the space occupied.

The viewing assembly of the present invention can be constructed from lightweight materials to provide a binocular stereoscope suitable for wearing on the viewer's nose without discomfort and a low manufacturing cost. With the movable reflector units and the adapter units, the viewing assembly can be adjusted to view pairs of images which are aligned horizontally with arbitrary space in between, or arranged vertically with arbitrary space in between but not necessarily aligned. The two-dimensional visual objects to be viewed by the viewing assembly include, but not limited to the images and moving pictures shown on the display monitors of computer systems or TV sets, photographs, prints and projected slides. The areas of applications of the viewing assembly are also not limited, and conceivably include entertainment, education, telecommunication, e-commerce, surveillance and many other fields.

Even though some embodiments of the present invention are given above for description, it will be apparent to those skilled in the art that the invention may be embodied still otherwise without departing from the spirit and scope of the invention.

I claim:

1. A viewing assembly for viewing pairs of stereo images which are spaced apart horizontally or vertically comprising:
a spectacle unit including arms for attaching said viewing assembly to a viewer's head and a bearer defining a joint part and a pair of sight openings,
a pair of reflector units attached to the bearer of the spectacle unit for directing the light of horizontally aligned images along separate paths toward the viewer's eyes, or attached to adapter units for directing the light of vertically arranged images along separate paths toward the viewer's eyes,
said reflector unit including a pair of mirrors for directing the line of sight, a magnifying lens for enhancing visual quality and guiding bars for attaching to the joint part defined on the bearer of the spectacle unit;
a pair of adapter units attached to the bearer of the spectacle unit for bearing the reflector units, said adapter unit including a plate defining an opening, a joint part on the front side and a joint part on the back side;
an attachment means for attaching the reflector unit and the adapter unit to the spectacle unit and allowing the reflector unit and the adapter unit to move horizontally or vertically for adjusting the field of vision of each eye, said attachment means including the joint part defined on the front side of the bearer and the guiding bars installed on the reflector unit, said attachment means further including the joint part defined on the front side of the adapter unit for bearing the reflector units and the joint part defined on the back side of the adapter unit for attaching to the joint part defined on the bearer of the spectacle unit.

2. The viewing assembly as claimed in clam 1, wherein said joint part defined on the front side of the bearer and said joint part defined on the front side of the adapter unit include L-shaped rails and associated attachment slots into which the guiding bars of the reflector units slide for attachment and movement.

3. The viewing assembly as claimed in clam 1, wherein said joint part defined on the back side of the adapter unit includes joining bars to slide into the attachment slots of the joint part defined on the bearer of the spectacle unit and the associated slots.

4. The viewing assembly as claimed in clam 3, wherein said joining bar on the back side of the adapter unit has a gentle slope in relation to the plate of the adapter unit for directing the line of sight inwardly.

5. The viewing assembly as claimed in clam 1, wherein said joint part defined on the front side of the bearer additionally includes a block placed in the middle of the associated attachment slot to prevent the reflector unit or the adapter unit from crossing over the middle point.

6. The viewing assembly as claimed in clam 2, wherein said attachment slots include fasten means for firmly holding and flexibly moving the reflector unit or the adapter unit.

7. The viewing assembly as claimed in clam 6, wherein said fasten means includes a elastic material or wave-shaped bands installed in said attachment slots.

8. The viewing assembly as claimed in clam 7, wherein said fasten means includes a protrusion installed on said guiding bars for firm attachment.

9. The viewing assembly as claimed in clam 7, wherein said fasten means includes rounded edges on two ends of the guiding bar for smooth sliding in the attachment slots.

10. The viewing assembly as claimed in clam 1, wherein said adapter unit includes a block near the bottom edge of the plate for preventing the reflector unit from falling off the adapter units.
